(19) United States
(12) Patent Application Publication
(10) Pub. No.: US 2021/0375085 A1
(43) Pub. Date: Dec. 2, 2021

(54) MONEY STORAGE DEVICE AND CHECKOUT DEVICE

(71) Applicant: TOSHIBA TEC KABUSHIKI KAISHA, Tokyo (JP)

(72) Inventors: Akiko HIRAYAMA, Yokohama Kanagawa (JP); Tsuyoshi GOTANDA, Ota Tokyo (JP); Jun KIKUCHI, Tagata Shizuoka (JP); Jun YOSHITOMI, Koganei Tokyo (JP)

(21) Appl. No.: 17/184,499

(22) Filed: Feb. 24, 2021

(30) Foreign Application Priority Data
Jun. 1, 2020 (JP) 2020-095745

(51) Int. Cl. G07D 11/14; G07G 1/00; G07G 1/01; G07D 11/12; G07D 11/16; G07D 11/235

(52) U.S. Cl. CPC G07D 11/14; G07G 1/0018; G07D 11/235; G07D 11/12; G07D 11/16; G07G 1/01

(57) ABSTRACT

A money storage device includes a change machine configured to store bills and coins, and a housing that houses the change machine. The housing includes a bill insertion port through which a bill is inserted, a coin insertion port through which a coin is inserted and arranged adjacent to the bill insertion port in a width direction of the housing, a bill discharge port through which a bill stored in the change machine is discharged and arranged below the bill insertion port and the coin insertion port, and a coin discharge port through which a coin stored in the change machine is discharged and arranged below the bill discharge port.

### CROSS-REFERENCE TO RELATED APPLICATIONS

This application is based upon and claims the benefit of priority from Japanese Patent Application No. 2020-095745, filed on Jun. 1, 2020, the entire contents of which are incorporated herein by reference.

### FIELD

Embodiments described herein relate generally to a money storage device and a checkout device related to retail transaction settlement.

### BACKGROUND

In recent years, for stores such as a supermarket, there has been introduced a self-checkout device which a customer operates by himself/herself to register and checkout commodities and so called a semi-self-checkout device at which a customer makes payment for commodities that have been registered by a store clerk. Such checkout devices have a payment insertion port permitting the depositing or inserting of bills and coins and a discharge port permitting the discharging of bills and coins as change or the like.

However, since conventional checkout devices have the insertion port and the discharge port at different positions, it may take time for a customer to find the locations, and there is also a possibility that coins and/or bills may be left behind. As such, there is room for further improvement in operability of these devices.

### BRIEF DESCRIPTION OF THE DRAWINGS

FIG. 1 is a front view of a checkout device according to an embodiment.

FIG. 2 is an external view of a checkout device according to an embodiment.

FIG. 3 is a diagram showing a bill insertion port and a coin insertion port of a checkout device according to an embodiment.

FIG. 4 is a diagram showing a bill discharge port and a coin discharge port of a checkout device according to an embodiment.

FIG. 5 is a schematic cross-sectional view taken along line L-L shown in FIG. 4.

FIG. 6 is a hardware diagram of a checkout device according to an embodiment.

FIG. 7. is a functional diagram of a checkout device according to an embodiment.

FIG. 8 is a flowchart of operations carried out by a checkout device according to an embodiment.

FIG. 9 is a diagram illustrating a bill insertion port and a coin insertion port of a checkout device according to a first modification.

FIG. 10 is a diagram illustrating a printer according to a second modification.

### DETAILED DESCRIPTION

In general, according to an embodiment, a money storage device includes a change machine configured to store bills and coins and a housing that houses the change machine. The housing includes a bill insertion port through which a bill can be inserted and a coin insertion port through which a coin can be inserted. The coin insertion port is adjacent to the bill insertion port in a width direction of the housing. A bill discharge port through which a bill stored in the change machine can be discharged is below the bill insertion port and the coin insertion port. A coin discharge port through which a coin stored in the change machine can be discharged is below the bill discharge port.

Hereinafter, certain example embodiments of a checkout device will be described with reference to the drawings. In one example embodiment, a semi-self-checkout device at which a customer performs checkout of commodities that have been registered by a store clerk will be described. It is assumed that such a checkout device is connected, via a network, to a registration device operated by a store clerk, and can acquire transaction information indicating details (such a commodity name, a price, a purchase reward point amount, a total amount due, and the like) of each commodity from the registration device, a store server, or the like.

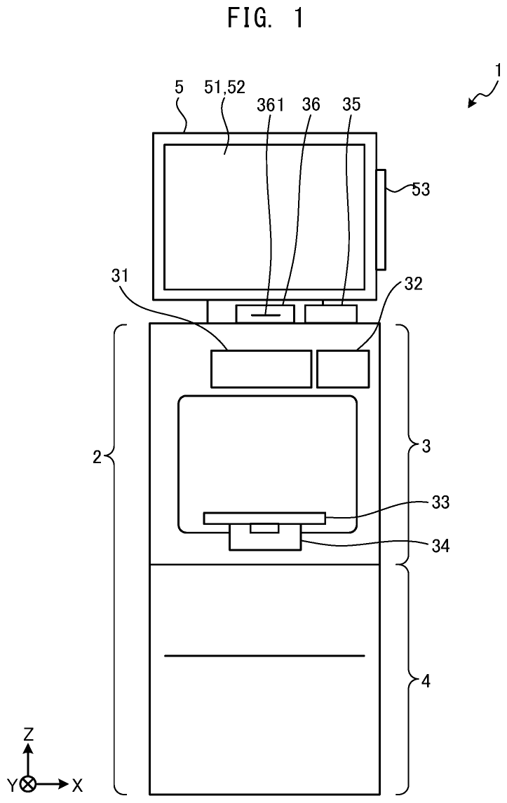

FIG. 1 is a front view illustrating a checkout device 1 according to an embodiment. In the drawings described below, the X direction means a width direction of the checkout device 1 when viewed from the operator facing side. The Y direction means a depth direction of the checkout device 1. The Z direction means a height direction or vertical direction of the checkout device 1.

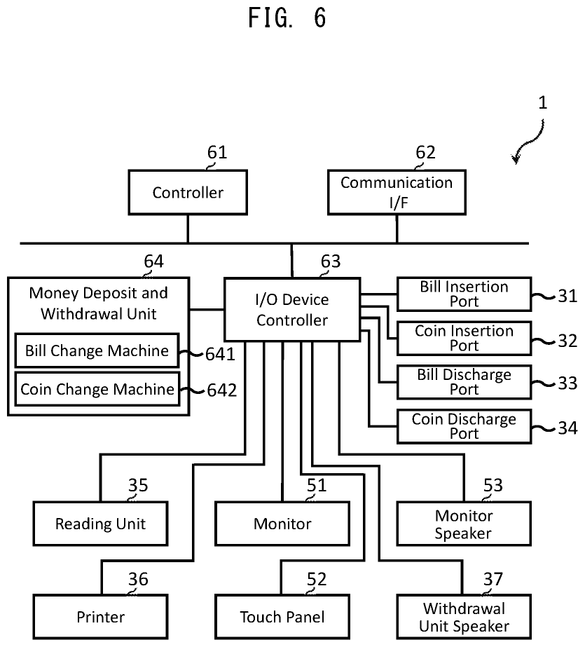

As illustrated in FIG. 1, the checkout device 1 includes a main body 2 and a display operation unit 5. The main body 2 includes a first housing 3 and a second housing 4. The first housing 3 houses a money deposit and withdrawal unit 64 (see FIG. 6, hereinafter also referred to as “change machine”) for the operator to deposit and withdraw money, particularly in this example, bills and coins. The first housing 3 includes a bill insertion port 31, a coin insertion port 32, a bill discharge port 33, and a coin discharge port 34 on the front surface of the checkout device 1 facing the operator.

The first housing 3 includes a reading unit 35. The reading unit 35 reads information from a medium such as a credit card. For example, as illustrated in FIG. 1, the reading unit 35 is installed on the upper surface of the first housing 3.

The first housing 3 includes a printer 36 that prints a receipt or the like. The printer 36 discharges a receipt on which details of a transaction are printed from a receipt discharge port 361. For example, as shown in FIG. 1, the printer 36 is installed on the upper surface of the first housing 3.

The second housing 4 supports the first housing 3 from below. The second housing 4 houses, for example, a controller 61 (see FIG. 6) that controls the operation of the checkout device 1. The first housing 3 is supported at a height at which the operator can easily insert or take money via the bill insertion port 31, the coin insertion port 32, the bill discharge port 33, and the coin discharge port 34.

The display operation unit 5 stands on the upper surface of the main body 2 (or the first housing 3) via a support member such as a stand. The display operation unit 5 includes a monitor 51, a touch panel 52, and a monitor speaker 53.

The monitor 51 displays a screen or the like under the control of the controller 61 described later. The touch panel 52 is provided on the surface of the monitor 51, and outputs information based on a position touched by the operator to the controller 61 (see FIG. 6). Under the control of the controller 61, the monitor speaker 53 outputs a sound for explaining how to operate the checkout device 1.

Next, the bill insertion port 31, the coin insertion port 32, the bill discharge port 33, and the coin discharge port 34 will be described.

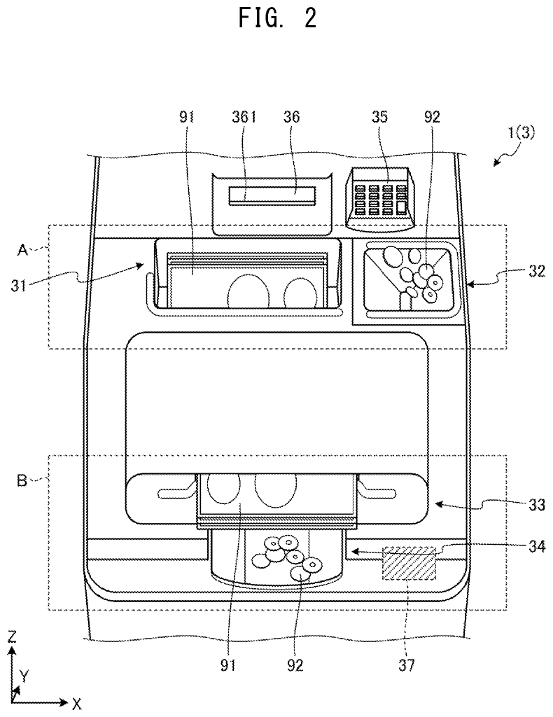

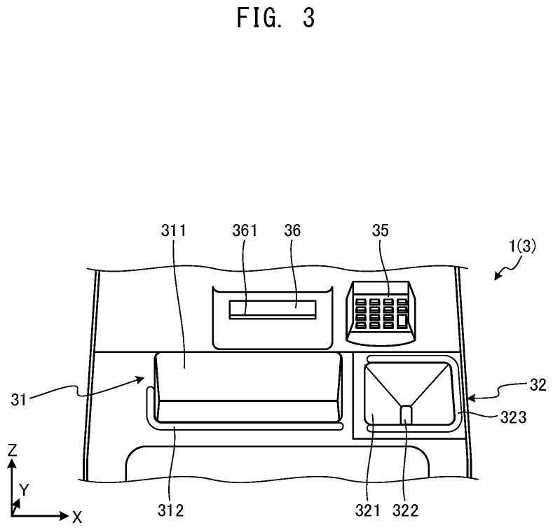

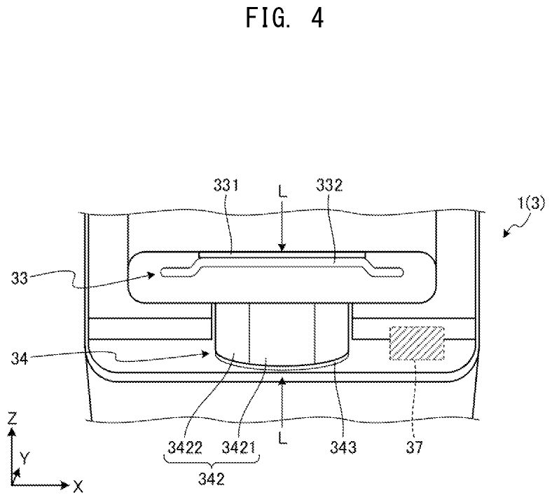

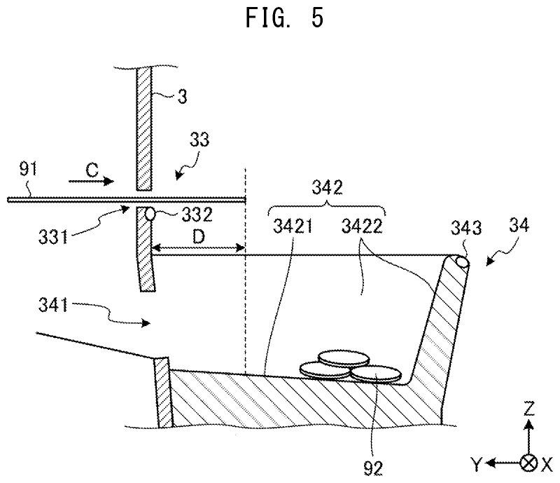

FIG. 2 is an external view of the checkout device 1 (or the first housing 3) as viewed from above. FIG. 3 is a view showing the periphery of the bill insertion port 31 and the coin insertion port 32 shown in FIG. 2. FIG. 4 is a view showing the periphery of the bill discharge port 33 and the coin discharge port 34 shown in FIG. 2. FIG. 5 is a cross-sectional view of the bill discharge port 33 and the coin discharge port 34 taken along line L-L shown in FIG. 4.

FIG. 2 shows the first housing 3 as viewed from the operator standing in front of the checkout device 1. Here, the eye-level height of the operator is assumed to be around the height of the display operation unit 5, and the view of the first housing 3 from that operator is shown in FIG. 2.

As described above, the checkout device 1 includes the bill insertion port 31, the coin insertion port 32, the bill discharge port 33, and the coin discharge port 34 on the front surface side of the first housing 3.

The bill insertion port 31 is provided in a step portion formed above the first housing 3. As shown in FIG. 3, the bill insertion port 31 includes a bill insertion opening 311 and a light emission unit 312.

The bill insertion opening 311 is a substantially rectangular opening that opens upward. The bill insertion opening 311 is formed horizontally along the width direction of the checkout device 1. The longitudinal dimension of the bill insertion opening 311 is greater than the long side of the largest size bill. The dimension of the bill insertion opening 311 in the lateral direction is larger than the thickness of one bill 91 having the largest thickness, and it is preferable that the plurality of bills 91 can pass therethrough in an overlapping manner. The depth of the bill insertion opening 311 is formed to be larger than the short side of the largest size bill.

That is, as shown in FIG. 2, the plurality of bills 91 can be inserted into the bill insertion opening 311 at one time in a state where the long side of the bill 91 is horizontal and the short side is vertical. The bill 91 inserted into the bill insertion opening 311 is transported to the money deposit and withdrawal unit 64 (or a bill change machine 641) in the first housing 3 by a transport mechanism.

The light emission unit 312 is provided around the bill insertion opening 311. For example, the light emission unit 312 is provided along the edge on the front surface side of the bill insertion opening 311 facing the operator. The light emission unit 312 is formed of a light emission member such as a LED (light emitting diode), a light transmissive light guide member, and the like, and light emission is controlled by the controller 61 described later.

In addition, the bill insertion port 31 includes a sensor device that detects the bill 91 inserted into the bill insertion opening 311, a shutter mechanism that opens and closes the bill insertion opening 311, and the like (none of them is shown). The sensor device is provided, for example, in the bill insertion opening 311 and detects the presence or absence of the bill 91. The detection result of the sensor device is output to the controller 61. The shutter mechanism opens and closes the bill insertion opening 311 under the control of the controller 61.

The coin insertion port 32 is provided in the same step as the bill insertion port 31. As shown in FIG. 3, the coin insertion port 32 includes a funnel-shaped inclined surface 321 descending from the outside to the inside, a hole or opening 322 provided at the lowermost portion of the inclined surface 321, and a light emission unit 323. Here, the inclined surface 321 and the hole 322 make up the coin insertion port 32. The coin insertion port 32 has an opening that opens upward.

The hole 322 has a size through which coins 92 can pass. Specifically, the longitudinal dimension of the hole 322 is greater than the diameter of the coin 92 having the largest diameter, and is greater than the thickness of the thickest coin in the width direction orthogonal to the longitudinal direction. The size of the hole 322 is preferably such that a plurality of coins 92 can pass therethrough even when the coins are in an overlapping manner. That is, the dimension of the hole 322 in the width direction is preferably larger than two times the thickness of the thickest coin 92 expected to be tendered for payment.

By arranging the inclined surface 321 and the hole 322 in this manner, the coin insertion port 32 can efficiently receive the coins 92 inserted from above. A coin 92 inserted into the hole 322 is transported to the money deposit and withdrawal unit 64 (or a coin change machine 642) in the first housing 3 by a transport mechanism.

The light emission unit 323 is provided around the inclined surface 321. For example, the light emission unit 323 is provided along the upper edge of the inclined surface 321. The light emission unit 323 is formed of a light emission member such as an LED, a light transmissive light guide member, and the like, and light emission is controlled by the controller 61 to be described later.

In addition, the coin insertion port 32 includes a sensor device that detects a coin 92 inserted into the hole 322, a shutter mechanism that opens and closes the hole 322, and the like. The sensor device is provided, for example, in the inclined surface 321 or the hole 322, and detects the presence or absence of the coins 92. The detection result of the sensor device is output to the controller 61. The shutter mechanism opens and closes the hole 322 under the control of the controller 61.

As shown in FIGS. 2 and 3, the bill insertion port 31 and the coin insertion port 32 described above are arranged side by side in the width direction of the checkout device 1 (or more particularly in the first housing 3). Specifically, the coin insertion port 32 is disposed close to one end side (e.g., the right side when viewed from the operator) in the width direction of the checkout device 1. The bill insertion port 31 is disposed on the other end side (e.g., the left side) in the width direction of the checkout device 1 and adjacent to the coin insertion port 32. In addition, the bill insertion port 31 is disposed to be horizontally long so as to straddle the center of the checkout device 1 in the width direction.

By installing the bill insertion port 31 and the coin insertion port 32 at the same height, the operator can easily insert money, and thus the operability can be improved. In addition, in the bill insertion port 31 and the coin insertion port 32, since the bill(s) 91 and the coin(s) 92 are inserted from above, it is possible to improve the visibility of the inserted money. Also, by adopting the same insertion method in which money are inserted from above at the bill insertion port 31 and the coin insertion port 32, money can be easily inserted even when the operator is unfamiliar with the operation, and thus the usability can be improved. Further, by arranging the bill insertion port 31 and the coin insertion port 32 side by side in the width direction of the checkout device 1, the required space in the depth direction of the checkout device 1 can be made compact, and therefore, the size of the checkout device 1 can be reduced.

On the other hand, as shown in FIG. 4, the bill discharge port 33 includes a bill discharge opening 331 and a light emission unit 332. The bill discharge opening 331 is a substantially rectangular opening that opens towards the operator, that is, the horizontal direction. The bill discharge opening 331 is disposed horizontally long in the width direction of the checkout device 1. The dimension in the longitudinal direction of the bill insertion opening 331 is larger than the long side of the bill 91 of the largest size. The dimension of the bill discharge opening 331 in the lateral direction is larger than the thickness of one bill 91 having the largest thickness, and it is preferable that a plurality of bills 91 can pass therethrough in an overlapping manner.

The bill discharge opening 331 discharges the bill 91 transported from the money deposit and withdrawal unit 64 (or the bill change machine 641) to the outside of the first housing 3 by a transport mechanism. Specifically, the bill discharge opening 331 discharges the bill 91, which is transported such that the short side of the bill 91 is parallel to the transport direction (the direction of arrow C in FIG. 5), to the outside of the checkout device 1. Thus, as shown in FIG. 2, the bill discharge opening 331 discharges the bill 91 horizontally with the long side of the bill 100 facing the operator. In addition, when there are multiple bills 91 to be discharged, the bill discharge port 33 discharges the bills 91 from the bill discharge opening 331 in a stacked state. A known technology can be used for the mechanism for discharging the bills 91 in a stacked state.

In addition, the bill discharge port 33 retains a part of the bill 91 in the bill discharge opening 331 by holding the rear end portion of the bill 91 with a roller or the like so that the bill 91 does not jump out from the bill discharge opening 331. In addition, the bill discharge port 33 exposes a part of the bill 91 from the bill discharge opening 331 to the outside of the first housing 3 so as not to cover the entire opening of a coin discharge tray 342. The length of the bill 91 exposed from the bill discharge opening 331 is also referred to as a protruding amount.

The light emission unit 332 is provided around the bill discharge opening 331. For example, the light emission unit 332 is provided along the edge of the bill discharge opening 331. The light emission unit 332 is a lamp such as an LED, a light transmissive light guide member, and the like, and light emission is controlled by the controller 61 to be described later.

In addition, the bill discharge port 33 includes a sensor device that detects the bill 91 discharged from the bill discharge opening 331, a shutter mechanism that opens and closes the bill discharge opening 331, and the like (none of them are shown). The sensor device is provided, for example, in the bill discharge opening 331 and detects the presence or absence of the bill 91. The detection result of the sensor device is output to the controller 61. The shutter mechanism opens and closes the bill discharge opening 331 under the control of the controller 61.

As shown in FIGS. 4 and 5, the coin discharge port 34 includes a coin discharge opening 341, the coin discharge tray 342 that receives the coin 92 discharged from the coin discharge opening 341 outside the first housing 3, and a light emission unit 343.

The coin discharge opening 341 is connected to a transport mechanism that transports the coins 92 dispensed from the money deposit and withdrawal unit 64 (or the coin change machine 642), and discharges the coins 92 transported by the transport mechanism to the coin discharge tray 342.

The coin discharge tray 342 is formed by a bottom surface 3421 and a side wall 3422 formed at an edge portion of the bottom surface 3421, and has an upward opening. For example, as illustrated in FIG. 5, the bottom surface 3421 is formed as an inclined surface descending from the back side to the front side of the checkout device 1, and holds the coin 92 discharged from the coin discharge opening 341. With such a shape, the coin 92 discharged from the coin discharge opening 341 can be moved to the front side of the coin discharge tray 342. The bottom surface 3421 may be a horizontal surface.

The side wall 3422 is formed, for example, as an inclined surface descending toward the bottom surface 3421. A corner portion connecting the bottom surface 3421 and the side wall 3422 is formed in a curved surface shape smoothly connecting the bottom surface 3421 and the side wall 3422. With this curved surface shape, the coin 92 can be smoothly slid from the bottom surface 3421 along the side wall 3422, so that the coin 92 can be easily taken out from the coin discharge tray 342 by the operator.

The light emission unit 343 is provided around the coin discharge tray 342. For example, the light emission unit 343 is provided along the edge on the front surface side of the light emission unit 343. The light emission unit 343 is a lamp such as an LED, a light transmissive light guide member, and the like, and light emission is controlled by the controller 61 to be described later.

In addition, the coin discharge port 34 includes a sensor device that detects the coin 92 discharged from the coin discharge opening 341, a shutter mechanism that opens and closes the coin discharge opening 341, and the like (none of them are shown). The sensor device is provided on, for example, the bottom surface 3421 or the side wall 3422 of the coin discharge tray 342, and detects the presence or absence of the coin 92. The detection result of the sensor device is output to the controller 61. The shutter mechanism opens and closes the coin discharge opening 341 under the control of the controller 61.

A withdrawal unit speaker 37 is provided around the bill discharge port 33 or the coin discharge port 34. For example, the withdrawal unit speaker 37 is disposed to the right of the coin discharge port 34. The withdrawal unit speaker 37 outputs a sound for notifying the operator of the presence of change in conjunction with the discharging operation of the bill discharge port 33 or the coin discharge port 34 under the control of the controller 61.

As described above, in the checkout device 1, since the withdrawal unit speaker 37 is provided around the bill discharge port 33 and the coin discharge port 34 from which change is actually discharged, it is possible to direct the operator's attention to the bill discharge port 33 and the coin discharge port 34 by outputting sound from the withdrawal unit speaker 37.

As shown in FIGS. 2 and 4, the bill discharge port 33 and the coin discharge port 34 described above are arranged side by side in the height direction of the checkout device 1 (or the first housing 3). Specifically, the bill discharge port 33 and the coin discharge port 34 are disposed substantially at the center in the width direction of the checkout device 1. The coin discharge port 34 is disposed below (or directly below) the bill discharge port 33 in the height direction of the checkout device 1. The coin discharge tray 342 of the coin discharge port 34 is disposed closer to the front side of the checkout device 1 than the bill discharge port 33 (or the bill discharge opening 331) in the depth direction of the checkout device 1.

As shown in FIG. 5, the protruding amount D of the bill 91 discharged from the bill discharge opening 331 of the bill discharge port 33 is limited so as not to cover the entire area of the opening of the coin discharge tray 342. That is, the coin 92 discharged from the bill insertion port 31 is held on the coin discharge tray 342 in a visible state without being covered by the bill 91 discharged from the bill discharge opening 331.

The protruding amount D may be adjusted according to the actual dimension of the bill discharge port 33 and the coin discharge port 34.

For example, the protruding amount D may be a value that covers one third of the opening of the coin discharge tray 342. The protruding amount D may be mechanically controlled by a transport mechanism of the bill 91 or a mechanism included in the bill discharge opening 331, or may be controlled by software by controlling the transport amount of the bills 91.

In this way, by arranging the bill discharge port 33 and the coin discharge port 34 side by side in the height direction and arranging the coin discharge tray 342 of the coin discharge port 34 on the front side of the bill discharge opening 331 of the bill discharge port 33, the operator can easily check the discharged change. Therefore, in the checkout device 1, it is possible to improve the visibility of the change, and it is possible to reduce the number of cases where the change is left behind or forgotten to be taken by the operator.

In addition, since the protruding amount D of the bill 91 discharged from the bill discharge opening 331 is limited so as not to cover the entire area of the opening of the coin discharge tray 342, the operator can easily check the coin 92 discharged to the coin discharge tray 342. Therefore, in the checkout device 1, it is possible to reduce the number of cases where the coin 92 discharged as change is left behind or forgotten to be taken by the operator.

In addition, by arranging the bill discharge port 33 and the coin discharge port 34 side by side in the height direction of the checkout device 1, it is possible to secure a large size of the coin discharge tray 342 in the width direction. Thus, the checkout device 1 can increase the retention amount of the coins 92 discharged as change. In addition, in the checkout device 1, it is possible to improve the visibility of the discharged coin 92 and make it easy for the operator to take out the coin 92.

Further, focusing on the overall arrangement of the bill insertion port 31, the coin insertion port 32, the bill discharge port 33, and the coin discharge port 34, as shown in FIG. 2, the bill insertion port 31 and the coin insertion port 32 are provided in a region A, and the bill discharge port 33 and the coin discharge port 34 are provided in a region B. Here, the region A is located above the region B. The region A and the region B are separated by a predetermined length.

In this manner, the bill insertion port 31 and the coin insertion port 32 related to the insertion of the money are arranged in the region A, and the bill discharge port 33 and the coin discharge port 34 related to the discharge of the change are arranged in the region B. Thus, it is possible to make it easy for the operator to recognize the location of each port. Accordingly, in the checkout device 1, it is possible for the operator to intuitively grasp the location of the port to which the money is to be inserted or from which the change is to be taken, and thus improve the operability.

Further, in the checkout device 1, the bill insertion port 31 (or the bill insertion opening 311) and the coin insertion port 32 are open upward, and the money discharged from the bill discharge port 33 and the coin discharge port 34 is discharged in the horizontal direction. Accordingly, when viewing the front surface of the checkout device 1 from above, the operator can easily see the bill insertion port 31 (or the bill insertion opening 311), the coin insertion port 32, the bill discharge port 33 (or the bill discharge opening 331), and the coin discharge port 34 (or the coin discharge tray 342) as shown in FIG. 2. In addition, the operator can easily confirm the change by moving the line of sight to the region B after inserting the money in the region A. Therefore, in the checkout device 1, it is possible to improve operability and to reduce the number of cases where the change is left behind or forgotten to be taken by the operator.

Next, a hardware configuration of the checkout device 1 will be described with reference to FIG. 6. FIG. 6 is a diagram illustrating an example of a hardware configuration of the checkout device 1. As shown in FIG. 6, the checkout device 1 includes a controller 61.

The controller 61 includes a processor such as a CPU (Central Processing Unit), a ROM (Read Only Memory), a RAM (Random Access Memory), and the like. The ROM stores various programs executed by the CPU and various data. The RAM temporarily stores data and programs when the CPU executes the programs. The controller 61 controls each unit of the checkout device 1 by the CPU executing one or more programs read from the ROM and loaded into the RAM.

The program executed by the checkout device 1 is provided by a computer-readable recording medium such as a CD-ROM, a flexible disk (FD), a CD-R, or a DVD (Digital Versatile Disk) in an installable format or an executable format.

The program executed by the checkout device 1 may be stored in a computer connected to a network such as the Internet and provided via the network. Further, the program executed by the checkout device 1 may be stored in the ROM or the like in advance.

A communication I/F 62 is a network interface circuit connected to the controller 61. The communication I/F 62 can be connected to a network such as a LAN (Local Area Network). The communication I/F 62 controls communication with an external device connected to the network. For example, the communication I/F 62 receives transaction information indicating a total amount of commodities to be checked-out.

In addition to the above-described bill insertion port 31, the coin insertion port 32, the bill discharge port 33, the coin discharge port 34, the reading unit 35, the printer 36, the withdrawal unit speaker 37, the monitor 51, the touch panel 52, the monitor speaker 53, and the like, the money deposit and withdrawal unit 64 is connected to the controller 61 via an I/O device controller 63 and the like. The controller 61 controls each device connected to the I/O device controller 63 to cooperate with each other, thereby controlling the operation of the checkout device 1.

Although FIG. 6 shows the bill insertion port 31, the coin insertion port 32, the bill discharge port 33, and the coin discharge port 34 directly connected to the I/O device controller 63, the components actually connected are electrically controllable components such as light emission units (the light emission unit 312, the light emission unit 323, the light emission unit 332, and the light emission unit 343), sensor devices, and shutter mechanisms.

The money deposit and withdrawal unit 64 stores money paid for checkout or to be dispensed as change. The money deposit and withdrawal unit 64 performs depositing and dispensing processes. Specifically, the money deposit and withdrawal unit 64 includes a bill change machine 641 that accepts and dispenses bills 91 and a coin change machine 642 that accepts and dispenses coins 92.

The bill change machine 641 is connected to the bill insertion port 31 via a transport mechanism, determines whether the bills 91 inserted via the bill insertion port 31 are genuine, and stores the genuine bills. The bill change machine 641 is connected to the bill discharge port 33 via a transport mechanism, and dispenses bills 91 as change from the bill discharge port 33. When the bill change machine 641 determines that the bill is a non-genuine bill (e.g., a foreign bill, a counterfeit bill, or the like), the bill change machine 641 causes the bill discharge port 33 to dispense the non-genuine bill without storing the non-genuine bill.

The coin change machine 642 is connected to the coin insertion port 32 via a transport mechanism, and determines whether the coins 92 inserted via the coin insertion port 32 are genuine and stores the genuine coins. The coin change machine 642 is connected to the coin discharge port 34 via a transport mechanism, and dispenses the coins 92 as change from the coin discharge port 34. When the coin change machine 642 determines that an inserted coin is a non-genuine or invalid coin type (e.g., a foreign coin, a counterfeit coin, or the like), the coin change machine 642 causes the coin discharge port 34 to reject the non-genuine coin without storing the non-genuine coin.

A reject unit different from the coin discharge port 34 may be provided. The reject unit receives the coins determined as a non-genuine coin by the coin change machine 642. The reject unit includes, for example, a discharge port for discharging the non-genuine coin, and a reject tray for receiving the non-genuine coin discharged from the discharge port outside the first housing 3. The reject unit may include a light emission unit in the reject tray or the like, similarly to the coin discharge port 34.

The reject unit may be provided side by side with the coin discharge port 34 in the width direction at the same height as the coin discharge port 34. In such a case, the reject unit is disposed in the same region B as the coin discharge port 34 that discharges the genuine coins, and the operator can easily recognize the location where bills or coins are returned. Accordingly, in the checkout device 1, it is possible for the operator to easily and visually recognize a part of the checkout device 1 where genuine and non-genuine money are returned and a part of the checkout device 1 where money is inserted. In other words, it is possible to allow the operator to intuitively grasp a part of the checkout device 1 to be operated. As a result, the operability of the checkout device 1 is improved.

The bill change machine 641 and the coin change machine 642 notify the controller 61 of the amount of the stored money. The bill change machine 641 and the coin change machine 642 receive a notification of the amount to be dispensed as change from the controller 61.

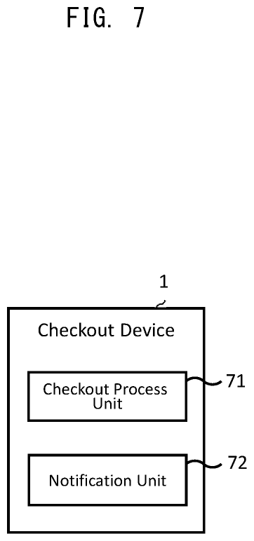

Next, the functions of the checkout device 1 will be described with reference to FIG. 7. FIG. 7 is a functional diagram of the checkout device 1. As illustrated in FIG. 7, the checkout device 1 includes a checkout process unit 71 and a notification unit 72.

A part or all of the checkout process unit 71 and the notification unit 72 may be implemented as one or more programs stored in the ROM of the checkout device 1 and carried out by the processor. A part or all of the checkout process unit 71 and the notification unit 72 may be implemented by a dedicated circuit.

The checkout process unit 71 executes checkout process of a commodity to be purchased by the operator. For example, the checkout process unit 71 acquires transaction information of each commodity registered by the registration device, and executes the checkout process based on the total amount of the commodities included in the transaction information.

Specifically, the checkout process unit 71 receives information about the amount of money inserted via the bill insertion port 31 and the coin insertion port 32 (hereinafter, also referred to as the paid amount) from the bill change machine 641 and the coin change machine 642. The checkout process unit 71 executes a checkout process of paying the total amount of the commodity based on the paid amount indicated by the acquired information.

In a case where the bill insertion port 31 and the coin insertion port 32 are provided with shutter mechanisms, the checkout process unit 71 causes the shutter mechanisms of the bill insertion port 31 and the coin insertion port 32 to be in an open state when money is inserted.

When receiving the information about the paid amount, the checkout process unit 71 calculates a change amount by subtracting the total amount of the registered commodities from the paid amount. The checkout process unit 71 notifies the bill change machine 641 and the coin change machine 642 of the calculated change amount to discharge the change from the bill discharge port 33 and the coin discharge port 34. For example, the checkout process unit 71 notifies the bill change machine 641 of the denomination and the number of bills 91 to be discharged, and notifies the coin change machine 642 of the denomination and the number of coins 92 to be discharged.

In a case where a shutter mechanism is provided in the bill discharge port 33 and the coin discharge port 34, the checkout process unit 71 brings the shutter mechanisms of the bill discharge port 33 and the coin discharge port 34 to be in an open state at the time of discharging the change.

In addition, in a case where the protruding amount of the bill 91 is controlled by software, the checkout process unit 71 limits the protruding amount of the bill 91 exposed from the coin discharge opening 341 to a predetermined value by controlling a transport mechanism that transports the bill 91 from the bill change machine 641 to the bill discharge port 33.

Then, when the discharge of the change is completed, the checkout process unit 71 causes the printer 36 to print a receipt indicating details of the transaction such as the amount of each commodity, the total amount, the paid amount, and the change amount, and discharges the receipt from the receipt discharge port 361.

Further, the checkout process unit 71 causes the monitor 51 to display a screen showing information related to the above-described checkout process, and causes the monitor speaker 53 to output a sound for guidance on how to operate the checkout device 1 or the like.

When the read uniting 35 reads information related to electronic payment from a medium such as a credit card, the checkout process unit 71 executes a payment process of paying the total amount of the commodities based on the user ID assigned to the operator and the information related to electronic payment read from the medium.

The notification unit 72 cooperates with the checkout process unit 71 to notify the operator of the ports to which money is to be inserted and from which change is discharged.

Specifically, the notification unit 72 notifies the operator of the insertion port of money by causing the light emission unit 312 of the bill insertion port 31 and the light emission unit 323 of the coin insertion port 32 to emit light when the money is to be paid. Accordingly, in the checkout device 1, the operator of the checkout device 1 can recognize the port where the money is inserted, and thus it is possible to improve operability related to the payment of the money.

When the change is discharged, the notification unit 72 notifies the operator of the discharge port of the change by causing the light emission unit 332 of the bill discharge port 33 and the light emission unit 343 of the coin discharge port 34 to emit light. For example, when the bill 91 is discharged as change, the notification unit 72 notifies the operator that change is discharged from the bill discharge port 33 by causing the light emission unit 332 provided in the bill discharge port 33 to emit light. In addition, for example, when the coin 92 is discharged as change, the notification unit 72 notifies the operator that change is discharged from the coin discharge port 34 by causing the light emission unit 343 provided in the coin discharge port 34 to emit light.

As described above, in the checkout device 1, when the discharge operation of the change occurs in one or both of the bill 91 and the coin 92 during the checkout process, the notification is performed using the light emission unit of the discharge port from which the change is discharged. Accordingly, since the notification unit 72 can cause the operator of the checkout device 1 to recognize the port where the change is discharged, it is possible to reduce the number of cases where the change is left behind or forgotten to be taken.

The notification unit 72 may cause one or both of the light emission unit 332 and 343 to continuously emit light or blink to intermittently emit light.

In addition, when the change is discharged, the notification unit 72 notifies the operator of the presence of the change by outputting a sound indicating the presence of the change, the denomination (bill or coin) of the discharged change, or the like from the withdrawal unit speaker 37. For example, when the bill 91 is discharged as change, the notification unit 72 notifies that the bill 91 is discharged as change by a predetermined sound. In addition, for example, when the coin 92 is discharged as change, the notification unit 72 notifies that the coin 92 is discharged as change by a predetermined sound.

In this way, in a case where one or both of the bill 91 and the coin 92 is returned as the change during the checkout process, the notification unit 72 notifies the presence and/or the denomination of the change by using the withdrawal unit speaker 37 present in the region B in which the bill discharge port 33 and the coin discharge port 34 are provided. Thus, in the checkout device 1, the operator of the checkout device 1 can recognize the presence of the change and the port where the change is discharged, it is possible to reduce the number of cases where the change is left behind or forgotten to be taken.

In addition, the notification unit 72 notifies the operator of the presence of change and the denomination using the withdrawal unit speaker 37 provided in the region B. Thus, in the checkout device 1, it is possible to further reduce the number of cases where the change is left behind or forgotten to be taken by the operator.

The timing at which the notification unit 72 causes the withdrawal unit speaker 37 to output a sound may be the same as the light emission timing at which the light emission unit 332 or the light emission unit 343 emits light, or may be after the light emission timing. In the latter case, for example, when the presence of change has been detected by the sensor devices provided in the bill discharge port 33 and the coin discharge port 34 for a predetermined time (for example, 3 seconds or the like), a predetermined sound may be output from the withdrawal unit speaker 37.

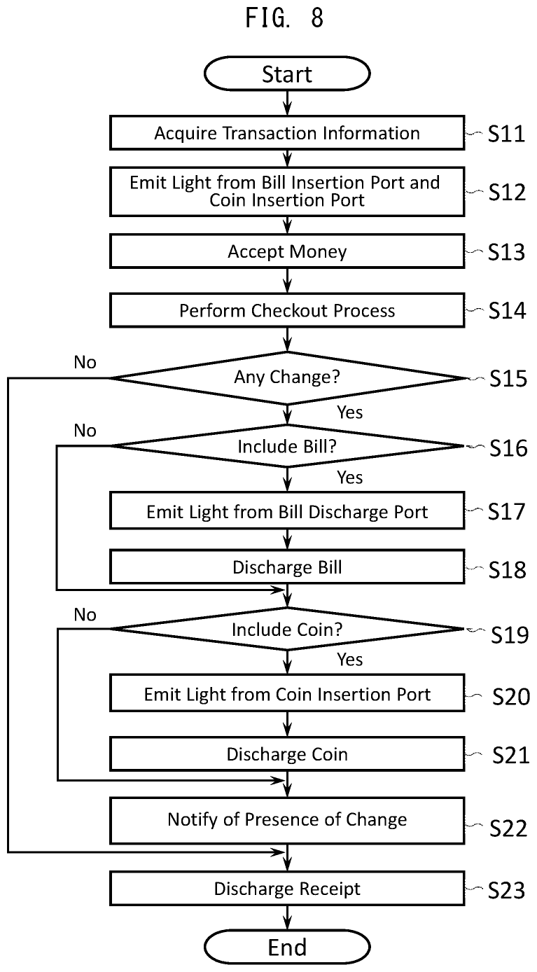

Hereinafter, the operation of the checkout device 1 will be described with reference to FIG. 8.

FIG. 8 is a flowchart illustrating process executed by the checkout device 1. Here, it is assumed that registration of a commodity to be purchased by the operator of the checkout device 1 has been completed.

First, the checkout process unit 71 acquires transaction information for an operator or customer who is performing the checkout process from the registration device, the store server, or the like (Step S11).

Subsequently, the notification unit 72 causes the light emission unit 312 of the bill insertion port 31 and the light emission unit 323 of the coin insertion port 32 to emit light, thereby notifying the operator of the insertion port of money (Step S12). When the money is inserted into the bill insertion port 31 and/or the coin insertion port 32, the checkout process unit 71 receives information indicating the amount of the inserted money (i.e., paid amount) through the bill change machine 641 and the coin change machine 642 (Step S13).

Subsequently, the checkout process unit 71 executes the checkout process based on the paid amount indicated by the information received in Step S13 (Step S14). Next, the checkout process unit 71 determines the presence or absence of change on the basis of the difference between the total amount of the commodities and the paid amount (Step S15). When it is determined that there is no change (No in Step S15), the process proceeds to Step S23.

On the other hand, when it is determined that there is a change (Yes in Step S15), the checkout process unit 71 proceeds to Step S16 and determines whether a bill 91 is included in the change (Step S16). When it is determined that the change includes a bill 91 (Yes in Step S16), the notification unit 72 causes the light emission unit 332 provided in the bill discharge port 33 to emit light, thereby notifying the operator that there is a bill 91 discharged as the change (Step S17). In addition, the checkout process unit 71 discharges the bill 91 from the bill discharge port 33 by cooperating with the bill change machine 641 (Step S18), and proceeds to Step S19.

When the checkout process unit 71 determines that the change does not include a bill 91 (No in Step S16), the process immediately proceeds to Step S19.

In Step S19, the checkout process unit 71 determines whether a coin 92 is included in the change (Step S19). When it is determined that a coin 92 is included in the change (Yes in Step S19), the notification unit 72 causes the light emission unit 343 provided in the coin discharge port 34 to emit light, thereby notifying the operator that a coin 92 is discharged as the change (Step S20). In addition, the checkout process unit 71 discharges the coin 92 from the coin discharge port 34 by cooperating with the coin change machine 642 (Step S21), and proceeds to Step S22.

In addition, in a case where it is determined that a coin 92 is not included in the change (No in Step S19), the process immediately proceeds to Step S22. The process order of Steps S16 to S18 and Steps S19 to S21 is not limited thereto, and may be modified.

Subsequently, the notification unit 72 notifies the operator of the presence of the change by outputting a sound for notifying the presence of the change, the denomination, and the like from the withdrawal unit speaker 37 (Step S22). Then, the checkout process unit 71 causes the printer 36 to print a receipt indicating the details of the transaction, and discharge the receipt from the receipt discharge port 361 (Step S23).

The above-described embodiments can be appropriately modified and implemented by changing a part of the components or functions of the above-described checkout device 1. Some modifications of the above-described embodiment will be described below as other embodiments. In the following, the differences from the above-described embodiments will be mainly described. The modifications described below may be implemented individually or in appropriate combination.

(Modification 1)

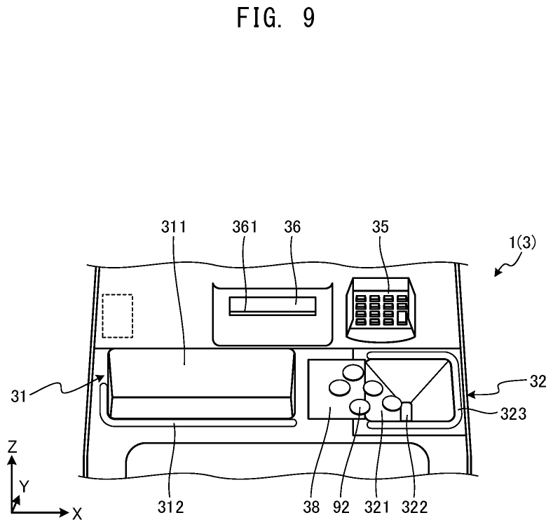

In the above-described embodiments, the bill insertion port 31 and the coin insertion port 32 are disposed adjacent to each other. However, the configuration is not limited thereto, and a gap may be provided between the bill insertion port 31 and the coin insertion port 32. For example, as shown in FIG. 9, a planar region (hereinafter, also referred to as a placement portion 38) may be provided between the bill insertion port 31 and the coin insertion port 32.

FIG. 9 is a diagram illustrating the bill insertion port 31 and the coin insertion port 32. As shown in FIG. 9, the placement portion 38 is provided between the bill insertion port 31 and the coin insertion port 32.

Here, the placement portion 38 can be used for the operator to temporarily place the coin 92, for example. Specifically, before inserting a bill 91 or a coin 92 into the bill insertion port 31 or the coin insertion port 32, the operator can place some coins 92 on the placement portion 38, and then insert only the required amount of coins into the coin insertion port 321 or the hole 322.

In particular, by smoothly connecting the placement portion 38 and the inclined surface 321 of the coin insertion port 32 adjacent to the placement portion 38, it is possible for the operator to slide the coin 92 from the placement portion 38 toward the coin insertion port 32 to insert the coin 92 into the hole 322. Therefore, it is possible to improve operability related to insertion of the coin 92.

In order to prevent the coin 92 placed on the placement portion 38 from entering the bill insertion opening 311, a partition such as a side wall may be provided at an edge portion of the placement portion 38 other than a side adjacent to the coin insertion port 32 or an edge portion adjacent to the bill insertion opening 311.

Further, the coin 92 placed on the placement portion 38 may be prevented from entering the bill insertion opening 311 by forming the placement portion 38 at a position lower than the plane of the step portion in which the bill insertion port 31 (or the bill insertion opening 311) is provided and forming the shape of the placement portion 38 into a concave shape such as a dish shape recessed from the plane of the step portion. In such a case, the height of the inclined surface 321 of the coin insertion port 32 connected to the placement portion 38 is preferably the same as the height of the placement portion 38.

In addition, the position where the placement portion 38 is provided is not limited to a position between the bill insertion port 31 and the coin insertion port 32. For example, in the depth direction of the checkout device 1, the placement portion 38 may be provided on the back side or the front side of the coin insertion port 32. In addition, the placement portion 38 may be provided in a gap between the coin insertion port 31 and the other end side (i.e., the right end) in the width direction of the checkout device 1, which is formed by disposing the bill insertion port 31 close to one end side (for example, the left end) in the width direction of the checkout device 1 while the bill insertion port 32 and the coin insertion port 32 are adjacent to each other.

(Modification 2)

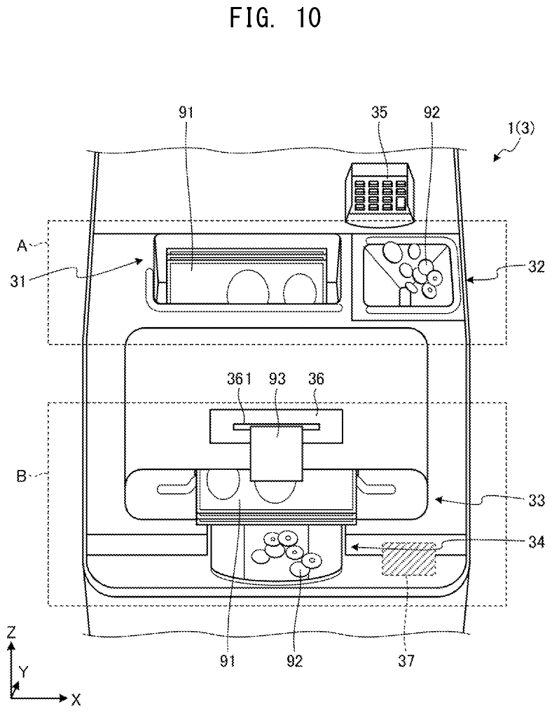

In the above-described embodiments, the printer 36 is disposed above the bill insertion port 31 and the coin insertion port 32. However, for example, as illustrated in FIG. 10, the printer 36 may be disposed above the bill discharge port 33 and below the bill insertion port 31 and the coin insertion port 32.

FIG. 10 is a diagram illustrating the printer 36. As shown in FIG. 10, the printer 36 is provided above the bill discharge port 33. In such a case, the printer 36 discharges the receipt 93 from the receipt discharge port 361 so that the receipt 93 is discharged above the bill 91 discharged as change.

With this arrangement, the bill discharge port 33, the coin discharge port 34, and the printer 36 that discharge the change and the receipt 93 can be arranged in the region B below the region A in which the bill insertion port 31 and the coin insertion port 32 are arranged. Accordingly, the operator can easily take out the discharged money and the receipt by moving the line of sight to the region B after inserting the money in the region A. In addition, since the operator can easily check the bill 91 and the coin 92 discharged as change and the receipt 93 as illustrated in FIG. 10 by moving the line of sight from the region A to the region B, it is possible to reduce the case where the change or the receipt 93 are left behind.

The arrangement position of the printer 36 is not limited to the example of FIG. 10. For example, the printer 36 may be disposed below the coin discharge port 34 or may be disposed side by side with the coin discharge port 34 in the width direction of the checkout device 1. In such a case, the operator can easily check the bill 91 and the coin 92 discharged as the change and the receipt 93 by moving the line of sight from the region A to the region B, and thus it is possible to reduce the case where the change or the receipt 93 are left behind.

(Modification 3)

In the above-described embodiments, in the depth direction of the checkout device 1, the edge portions on the front side of the bill insertion port 31 (or the bill insertion opening 311), the coin insertion port 32 (or the inclined surface 321), and the bill discharge port 33 (or the bill discharge opening 331) of are disposed at substantially the same position.

For example, in the depth direction of the checkout device 1, the region A and the region B may be arranged in a stepwise manner or in an inclined manner so that the region B is on the front side of the region A. In this way, the operator can more easily view all the insertion ports, the discharge ports, and discharge trays, and thus it is possible to further improve operability.

(Modification 4)

In the above-described embodiments, when change is discharged from the bill discharge port 33 and the coin discharge port 34, the notification is performed by using the light emission unit or the withdrawal unit speaker 37. However, the notification may be performed in the same manner when the non-genuine coin is discharged. In such a case, it is preferable that the notification unit 72 causes the withdrawal unit speaker 37 to output a sound for notifying that a non-genuine coin has been inserted.

As a result, the operator of the checkout device 1 can recognize that the non-genuine coin has been inserted, and thus the number of cases where the non-genuine coin is left behind or forgotten to be taken can be reduced.

(Modification 5)

In the above-described embodiments, the semi-self-checkout device is described. However, those embodiments are appliable to a self-checkout apparatus.

In such a case, in addition to the above-described configuration, the checkout device 1 includes a scanner device that reads a commodity code for specifying a commodity name, a price, or the like of a commodity from a code symbol such as a barcode attached to the commodity. In addition, the checkout process unit 71 executes the checkout process by using the total amount of the commodities which are registered by the scanner device in one transaction.

In addition, the aforementioned embodiments and modifications are applicable to a money storage device for storing bills and coins, a ticket vending machine or a ticket issuing machine that issues a meal ticket or the like at a restaurant, a checkout machine installed at a parking lot, a station, or the like, an automatic vending machine, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A money storage device, comprising:
a change machine configured to store bills and coins; and
a housing that houses the change machine and includes:
a bill insertion port through which a bill is inserted,
a coin insertion port through which a coin is inserted, the coin insertion port being adjacent to the bill insertion port in a width direction of the housing,
a bill discharge port through which a bill from the change machine is discharged, wherein the bill discharge port is located below the bill insertion port and the coin insertion port, and
a coin discharge port through which a coin stored in the change machine is discharged, wherein the coin discharge port is located directly under the bill discharge port.

2. The money storage device according to claim 1, wherein the housing includes a first area in which the bill insertion port and the coin insertion port are arranged and a second area located below the first area and in which the bill discharge port and the coin discharge port are arranged.

3. The money storage device according to claim 2, wherein the first area is separated from the second area in a vertical direction of the housing.

4. The money storage device according to claim 2, further comprising:
a speaker in the second area and configured to output a sound when a bill or a coin is discharged.

5. The money storage device according to claim 1, wherein
the bill insertion port includes an opening that is open upward and through which a bill can be inserted,
the coin insertion port includes an opening that is open upward and through which a coin can be inserted, and
the bill discharge port includes an opening that opens in a horizontal direction and through which a bill can be discharged.

6. The money storage device according to claim 5, wherein
the coin discharge port includes an opening through which a coin can be discharged and a coin discharge tray on a front side of the opening by which the discharged coin is received.

7. The money storage device according to claim 1, further comprising:
a printer configured to print a receipt, wherein
the housing further incudes a receipt discharge port between the bill insertion port and the bill discharge port and through which the receipt is discharged.

8. (canceled)

9. The money storage device according to claim 1, wherein the bill discharge port includes a lamp configured to emit light when a bill is discharged.

10. The money storage device according to claim 1, further comprising:
a controller configured to control a protrusion amount of a bill discharged from the bill discharge port towards outside.

11. A checkout device to be operated by a customer in a store, the checkout device comprising:
a display configured to display information about a transaction performed by a customer;
a change machine configured to store bills and coins paid by the customer; and
a first housing that houses the change machine and includes:
a bill insertion port through which a bill is inserted,
a coin insertion port through which a coin is inserted, the coin insertion port adjacent to the bill insertion port in a width direction of the first housing,
a bill discharge port through which a bill stored in the change machine is discharged, wherein the bill discharged port is located below the bill insertion port and the coin insertion port, and
a coin discharge port through which a coin stored in the change machine is discharged, wherein the coin discharge port is located directly under the bill discharge port.

12. The checkout device according to claim 11, wherein the first housing includes a first area in which the bill insertion port and the coin insertion port are arranged and a second area located below the first area and in which the bill discharge port and the coin discharge port are arranged.

13. The checkout device according to claim 12, wherein the first area is separated from the second area in a vertical direction of the first housing.

14. The checkout device according to claim 12, further comprising:
a speaker in the second area and configured to output a sound when a bill or a coin is discharged.

15. The checkout device according to claim 11, wherein
the bill insertion port includes an opening that is open upward and through which a bill can be inserted,
the coin insertion port includes an opening that is open upward and through which a coin can be inserted, and
the bill discharge port includes an opening that opens in a horizontal direction and through which a bill can be discharged.

16. The checkout device according to claim 15, wherein
the coin discharge port includes an opening through which a coin is discharged and a coin discharge tray on a front side of the opening by which the discharged coin is received.

17. The checkout device according to claim 11, further comprising:
a printer configured to print a receipt on which information about the transaction is printed, wherein
the first housing further incudes a receipt discharge port between the bill insertion port and the bill discharge port and through which the receipt is discharged.

18. (canceled)

19. The checkout device according to claim 11, wherein the bill discharge port includes a lamp configured to emit light when a bill is discharged.

20. The checkout device according to claim 11, further comprising:
a controller configured to control a protrusion amount of a bill discharged from the bill discharge port towards outside; and
a second housing that houses the controller, wherein
the display is above the first housing, and
the first housing is on the second housing.

21. The money storage device according to claim 1, further comprising:
a coin discharge tray by which the discharged coin is received, wherein
a center in the width direction of the coin discharge tray is aligned with a center in the width direction of the bill discharge port along a vertical direction perpendicular to the width direction.

22. The checkout device according to claim 11, wherein
the checkout device further comprises a coin discharge tray by which the discharged coin is received, and
a center in the width direction of the coin discharge tray is aligned with a center in the width direction of the bill discharge port along a vertical direction perpendicular to the width direction.
